(19) United States
(12) Patent Application Publication
(10) Pub. No.: US 2009/0164052 A1
(43) Pub. Date: Jun. 25, 2009

(54) DEVICE WITH INTERGRATED POSITION SENSOR

(76) Inventors: Ibrahim Doertoluk, Wiesthal (DE); Bernd Schnurr, Lohr (DE)

Correspondence Address: STRIKER, STRIKER & STENBY, 103 EAST NECK ROAD, HUNTINGTON, NY, 11743, US

(21) Appl. No.: 12/339,231

(22) Filed: Dec. 19, 2008

(30) Foreign Application Priority Data
Dec. 22, 2007 (DE) 10 2007 062 384.6

(51) Int. Cl. G05D 1/00

(52) U.S. Cl. 700/302

(57) ABSTRACT

The present invention relates to an actuator 10 for a movably situated device, in particular a device for joining stacked adherends 7, in particular a pair of welding tongs.

The object of the present invention is to realize a position-dependent control of a device, the position of which may be changed, while minimizing the additional effort or outlay required.

The present invention solves this problem by integrating a measuring means 2 for detecting at least one position-dependent measured quantity in the actuator, it also being possible to derive the position of actuator 10 from the measured quantity. The measuring means is enclosed in actuator 10.

This has the advantage that additional interference edges on the device on which the actuator is located may be avoided, and the position-dependent signal may be transmitted to higher-order controller 4 easily along with other signals that are transmitted by the actuator anyway.

The present invention describes an actuator for a movably situated device, in particular a device for joining stacked adherends, in particular a pair of welding tongs, according to independent claim 1, and a method for operating a drive device that includes an aforementioned actuator, according to independent claim 13.

The present invention relates to all areas of application in which the spacial position of a tool to be moved by an actuator must be influenced, the actuator being a part of the tool, or being movably supported in three dimensions together with the tool. In cases of this type, the spacial position of the tool has direct effects on the control variables of the actuator, since, depending on the spacial position, the natural weight of the tool must be taken into account in the controller to a lesser or greater extent, because the natural weight also affects the work piece. Exemplary applications of this type are found, e.g., in the field of robotic applications, in particular in connection with processing procedures that are carried out on work pieces.

From the prior art, it is known to realize a position-dependent control of a processing device for work pieces using a position sensor that is protected from external influences via a separate housing, and that is located on a device to be moved. The configuration of position sensors of this type usually takes place using mechanical switches (“DIP switches”), and is carried out manually. Since the sensor is located in a separate housing (IP65), which protects the sensor, e.g., from the effects of moisture, cost disadvantages result, because the special housing must be provided, and because assembly steps must be carried out on the device itself. The handling of a device of this type is extremely complex, because, e.g., in the case of the configuration of the position sensor, the housing must be opened in order to actuate the mechanical switch manually. In addition, a separate housing has the disadvantage that it has a direct influence on the outer contours of the device on which the housing is mounted. If this device is, e.g., a pair of welding tongs that must also extend into hard-to-reach angles of automobile bodies, it is easy to understand how applications of this type could cause the external housing to become damaged or the welding tongs to become torn off. This may result in expensive interruptions in the operation of the welding tongs.

Patent document DE 103 51126 B3 shows a device for the compensation of the weight that acts in the longitudinal direction on a displaceable piston rod of a position-variable pressure medium cylinder using an electronic control unit in order to control—in a manner that takes the weight into account—at least one multiple-direction valve that acts on the pressure medium cylinder on at least one side, a sensor being provided to detect the current position of the pressure medium cylinder, based on which the electronic control unit determines the current weight that is acting in the longitudinal direction on the displaceable piston rod, in order to determine—depending on the weight-compensating setpoint value—to control a multiple-direction valve that is designed as a pressure control valve.¹ ¹Translator's note: It appears that a direct object is missing after “to determine” in the German original. I have translated the text exactly.

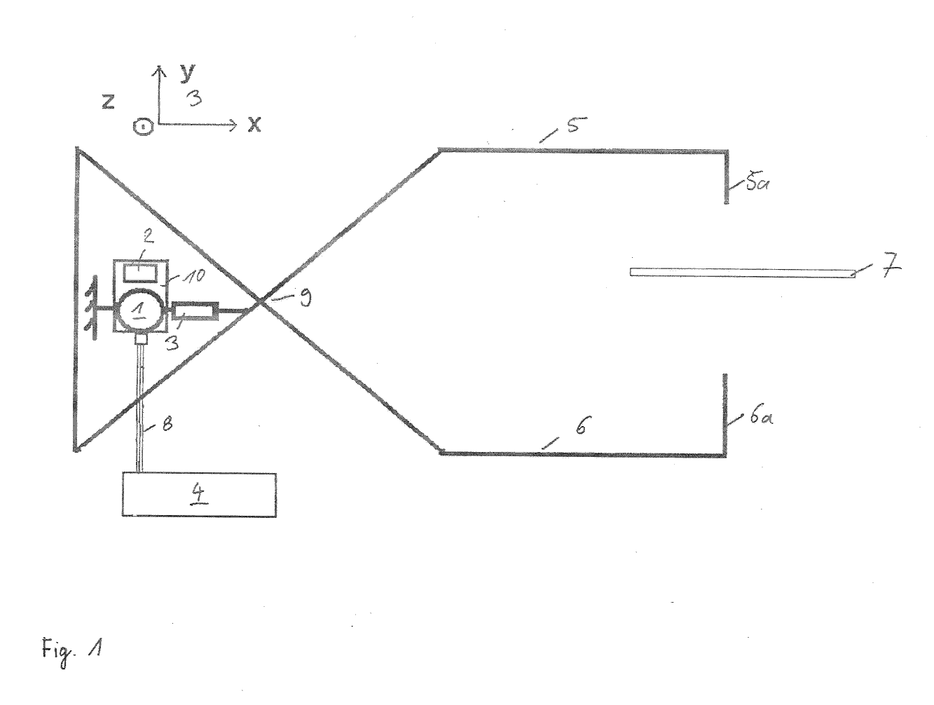

FIG. 1 in the aforementioned patent document also shows a pair of welding tongs that includes a position sensor. The welding tongs are essentially composed of a fixed carrier arm, which may also be mounted on a robot (not depicted). A static arm and a dynamic arm situated opposite thereto are hingedly mounted on the bearing of the carrier arm. A first welding electrode is assigned to the static arm, and a second welding electrode is assigned to the dynamic arm. The two welding electrodes are opened or closed via the application of pressure medium in the clamping cylinder, which is installed between the static arm and the dynamic arm, thereby enabling the pieces of sheet metal to be joined to one another via point welding. Due to the asymmetrical design of the welding tongs, the center of gravity of the tongs is not situated in the arm bearing. Since the pieces of sheet metal and the carrier arm have positional tolerances from welding point to welding point, the static arm is supported in a floating manner, i.e., it is provided with an additional degree of freedom. The static arm obtains the degree of freedom via the non-rigid attachment to the carrier arm using a pressure medium cylinder, which is therefore used as a type of compensating cylinder in this case. To ensure that the pieces of sheet metal do not become bent when the welding electrodes are set down in order to create a new welding point, the pressure differential in the pressure medium cylinder is adapted to the rotational angle of the welding tongs about the x-axis shown in FIG. 1. A multiple-direction valve that is designed as an electropneumatic pressure control valve, and that is equipped with an integrated sensor designed as an acceleration sensor is provided for this purpose. The multiple-direction valve is installed on the welding tongs in a manner such that the sensor only detects rotations about the x-axis. The fact described above, namely that the sensor unfavorably influences the contour of the welding tongs, is shown clearly in FIG. 1. The sensor is installed on the side of the lower dynamic arm. When the welding tongs move, e.g., through a narrow gap into a body component, the position sensor may be easily torn off of the welding tongs. If the sensor is placed in a protected location, then it is not easily accessible for the configuration.

The disadvantages that result from the stated prior art include, e.g., the need for a separate housing, and the fact that greater installation effort is therefore required. There are also disadvantages in terms of the contour influences, in terms of the large amount of cabling required between the position sensor housing and the further-processing unit, and in terms of the manual effort associated with the configuration of the sensor.

The object of the present invention, therefore, is to reduce the aforementioned disadvantages to the greatest extent possible, and to provide an actuator for a movably situated device that enables the spacially-changeable device to be controlled reliably without substantial extra effort, even in the most diverse spacial positions. A method for operating the actuator in conjunction with a drive is also be provided.

The present invention attains this object by the fact that the actuator includes a measuring means for detecting at least one position-dependent measured quantity, it also being possible to derive, from the measured quantity, the position of the actuator and/or the position of a device that is controlled by the actuator within at least one plane of the space within which the actuator or the device on which the actuator may be situated.² The measuring means enclosed by the actuator therefore delivers at least one output signal that may be changed automatically by the measuring means itself depending on the spacial position, in particular within at least one plane of the actuator. The goal of this solution is to compensate for the position-dependent components of the weight of the movable parts of the device, so that an object to be processed using the device is not loaded with the weight. ²Translator's note: It appears that a verb is missing in the German original (“within which the actuator or the device (verb)”. My impression is that the verb construction may be “ . . . is located”.

In the case of the solution according to the present invention, the measuring means is no longer located on the device itself, but rather is a component of the actuator, which is located on the device. “A component of the actuator” means that the position sensor may be located, e.g., inside the actuator housing or on the actuator housing (inside, outside, in a housing recess). A separate housing that would be needed otherwise is therefore not required in order to realize the solution, thereby also eliminating the additional installation expense required, including the cabling in particular. The additional interference edge on the device, which is required due to the separate housing, and as is known from the prior art, is also eliminated. It is also preferably possible to derive the tilt of the actuator within at least one plane of the space from the measured quantity.

The measuring means preferably outputs a sinusoidal signal, the phase angle of which may be used to deduce the spacial position of the actuator within the plane. The phase angle could contain, e.g., information about the position angle and the amplitude, and information about the weight components. This information would be easy to evaluate using a downstream controller. It would also be possible to derive the tilt of the actuator within the plane from the measured quantity.

Specific embodiments are defined using the dependent claims.

Particularly preferably, it is also possible to derive the dynamic acceleration of the actuator, in particular the static acceleration, and in particular the gravitation, from this measured quantity. This makes it possible to account for further state quantities that can occur during operation of the device to be controlled, which may be advantageous in particular for positional control that is as exact as possible. It would make sense to detect the dynamic acceleration, e.g., for purposes of deducing the acceleration for a positioning system (robot, compensating motor controller).

The measuring means is preferably designed to be so sensitive that a vibration of the actuator may also be derived from the measured data that are delivered by the measuring means. This means that the measuring means is realized with a sensitivity that allows it to respond even when the slightest changes in position take place, as may happen, e.g., within the framework of vibrations. Changes in position of this magnitude are in the millimeter range.

Very particularly preferably, several measuring means are enclosed by the actuator in a manner such that the position of the actuator may also be derived within various spacial planes using this measuring means. Three-dimensional spacial positions could therefore be depicted, provided this is required for the customer's application.

Advantageously, it is possible to parametrize the measuring means itself electronically. Manual mechanical access is therefore no longer required, and the measuring means may therefore be easily located inside the actuator housing, well-protected from external influences. Within the scope of parametrization, it could become necessary, e.g., to adjust the zero point in order to define the starting position of the actuator in space, or it could be possible to remotely adjust the amplification of an output signal that is generated using the measuring means. When the measuring means outputs a sinusoidal signal that is position-dependent, it would only be necessary, e.g., to also parametrize the amplitude to be output. The amplitude is also parametrized with consideration for the force of gravity F_{G}=m*g[N]. The position-dependent signal that is delivered by the measuring means is used to generate a setpoint value to control the actuator. The manner in which the force of gravity F_{G} is processed may be considered using the analogy of an inclined plane. The x-component of the weight, which is directed in the downward direction, depends on the angle of inclination (alpha) of the inclined plane. A counterforce defined as F=F_{G}*sin(alpha) is required to hold a mass stationary on an inclined plane. A comparable force must be applied by the actuator in order to compensate for the position-dependent weight of the device.

A drive device is required to start up the actuator. The drive device preferably comprises the actuator according to the present invention, and an operating means for supplying the actuator with operating data that are required to operate the actuator, the operating means being designed such that the operating data are determined with consideration for the measured quantities that are detected using the measuring means. The operating means receives, e.g., position-specific information from the actuator, and possibly additional information such as the instantaneous acceleration. The following method steps are provided to operate the drive device: 1. Detect the data on the measuring means using the operating means (e.g., position information, by evaluating the signal delivered by the measuring means, with regard for the amplitude and the phase). 2. Determine the operating data required to operate the actuator, with consideration for the data on the measuring means that were detected using the operating means (e.g., setpoint value generation). 3. Operate the actuator using the operating means with consideration for the operating data that were determined using the operating means (e.g., control the actuator using the setpoint value). The drive device may therefore ascertain the weight that is acting on the actuator as a function of the position of the device that is driven by the actuator, and it may operate the actuator as a function of this weight.

The operating means is preferably realized as a control device or a regulating device, or as a combination of a control device and a regulating device. For example, the operating means could be a traction control device, of the type offered by the applicant on the market under the name IndraDrive as of the date of submission of this application. The operating means is connected to the measuring means using a connecting means, and is realized in a manner such that the measuring means is parametrizable using the operating means. To realize the connection, a data transmission means is provided that is used in particular for the analog and/or digital transmission of data on the measuring means and/or of data on another displacement-measuring device that may be enclosed by the actuator, in order to measure the relative position of the actuator elements, which may move relative to one another.

To operate the actuator, the operating data are specified by the traction control device in the form of at least one setpoint value. A sinusoidal signal that is output by the measuring means could be processed by the traction control device with consideration for its instantaneous value, e.g., in a manner such that a setpoint value is derived from this signal. If the actuator is, e.g., a servo motor, the setpoint value could be a current setpoint value for the servo motor that is specified using a traction control device (IndraDrive) in a position-dependent manner. The setpoint value could also be specified in the form of a moment setpoint value, which is directly proportional to the current setpoint value, however. As an alternative to the aforementioned solution, the actuator could also be a pneumatic actuator or a hydraulic actuator, operating data also being specified in the form of one or more setpoint values to operate the particular actuator. These setpoint values are not current setpoint values or moment setpoint values, however, but rather, e.g., pressure setpoint values. Any other setpoint values could also be generated by the operating means, of course, with consideration for measured quantities that are detected by the measuring means, e.g., volume setpoint values, position setpoint values, displacement setpoint values, and speed setpoint values.

It would then be possible to parametrize the initialization of the measuring means, e.g., the definition of certain starting positions in space, and further parametrizations such as signal level, data formats, etc., using the operating means, remotely and automatically. The amplitude of the measured signal delivered by the measuring means is preferably parametrized with consideration for the force of gravity F_{G}=m*g[N].

To realize a connection between the operating means and the measuring means, a transmission means is provided that is used in particular to jointly transmit (in a digital and/or in an analog manner) data on the measuring means, and, preferably to simultaneously transmit data on another displacement-measuring device that is enclosed by the actuator, in order to measure the relative position of the actuator elements, which may move relative to one another. These data could then be transmitted, preferably jointly or preferably separately, between the actuator and the operating means using the same or several different data transmission means.

The present invention is explained below in a roughly schematic manner with reference to a few figures. These are exemplary embodiments that may also be modified in terms of the ability and level of knowledge of a person skilled in the art.

FIG. 1 shows the application of welding tongs.

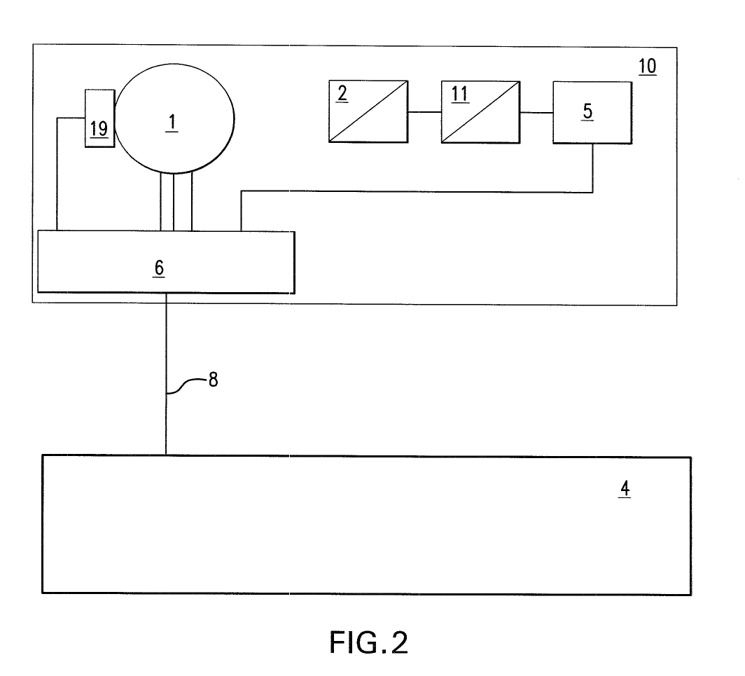

FIG. 2 illustrates the signal conditioning.

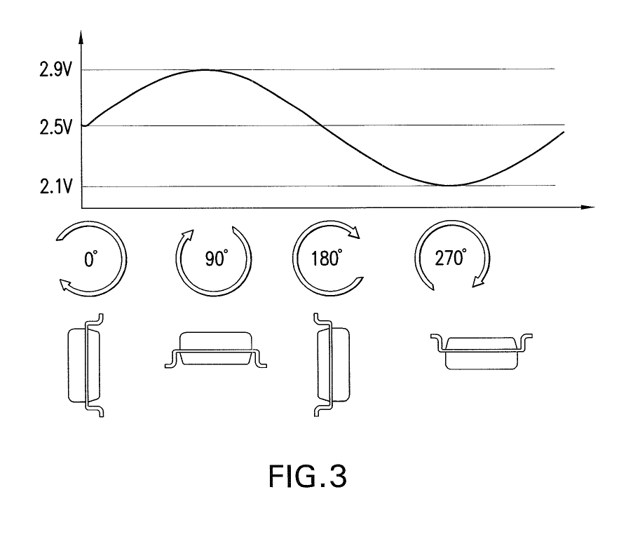

FIG. 3 is used to illustrate the mode of operation of the measuring means.

FIG. 1 is a schematic illustration of a pair of welding tongs 5, 6, 9, which is an X-shaped pair of welding tongs in this special example. Welding tongs include arms 5, 6, on which the welding electrodes 5a and 6a are situated. A piece of sheet metal 7, as the work piece, is indicated between electrodes 5a and 6a; sheet metal 7 will be provided with welding points. A compensating drive 10 is also shown, which may move the welding tongs, as an entire device, around rotational point 9 in a manner such that electrode 6a, which is designed as a reference electrode, may be moved closer to the underside of work piece 7 to be welded. Compensating drive 10 also includes a motor 1 and measuring means 2 according to the present invention, e.g., in the form of a position sensor 2 or an acceleration sensor 2. A mechanical unit 3 is indicated between compensating drive 10 and tong arms 5, 6, which transfers the motion of motor 1 to tong arms 5, 6. During the process of placing the electrodes, conveyance usually takes place using a linear motion, which, in this specific example, was realized using a rotating motor shaft and a suitable connecting rod, or using a linear motor. It would also be feasible to work with a circulating ball spindle, in order to convert the rotational motion into a linear motion. Compensating drive 10 is connected to a control unit 4 via a cable 8. Connection 8 is intended to be purely symbolic, and could also be realized in a wireless manner. The rotor position and the spacial position of the tongs as determined by measuring means 2 could be transmitted to control unit 4 via connection 8. This could take place simultaneously, e.g., within the framework of a commonly used data transmission protocol, or separately (parallel and/or serial, analog and/or digital). A transmission protocol 8 could be used simultaneously as a transmission medium for the electrical output to operate motor 1, and to regulate the rotor position and spacial position of the tongs. Transmission means 8 could also be realized as a hybrid cable by using different transmission media or transmission methods.

Compensating drive 10 is used to rotate the entire welding tongs arrangement around rotation point 9, and to therefore move reference electrode 6a close to object 7 to be welded. The motor setpoint moment or the motor current must be permanently adapted to the spacial position of the tongs, so that the object to be welded is always reached with the minimum amount of contact energy, to prevent the object (e.g., a piece of sheet metal) from becoming damaged (e.g., bent). Depending on the spacial position and/or spacial plane, a smaller or larger moment is required in the placement motion in order to compensate for the natural weight of welding tongs 5, 6. To realized this, position sensor 2 according to the present invention delivers position information to control unit 4 using transmission means 8. Control unit 4 calculates the required control parameters (motor moment, control time, etc.), and provides the moment setpoint value or the required current setpoint value to drive 10. Provided that the basic conditions allow it, and if it is considered to be advantageous for the application, the position information could also be transmitted, e.g., per WLAN or using any other type of wireless transmission technique.

In the current exemplary embodiment, a sensor was used as measuring means 2 that functions using a series circuit of two variable capacitors and a center tap situated between the two capacitors. While the supply lead and terminal lead of the sensor are connected to a first and second capacitor plate, respectively, a third capacitor plate is provided which is situated such that it may move relative to the first and second capacitor plates, and which may be electrically connected to the evaluation unit via the center tap. Depending on the position and/or acceleration of the sensor, this center plate is set into motion, thereby changing its distance from the first or second stationary plate, which has a direct effect on the measurable capacitance of the system, because the capacitance of the system results from the area of the plate multiplied by the permittivity constant, divided by the distance between the plates. It is now possible to digitize this signal that was received from the acceleration sensor, and to communicate it or transmit it in an analog manner to control unit 4 using means 8. Digital transmission is preferred, however, due to the lower susceptibility to interference. Sensors of any type that can detect the position of the actuator or the device directly or indirectly are suited for use for the purposes according to the present invention.

The conditioning of measured signals delivered by measuring means 2 using operating device 4 will now be described with reference to FIG. 2. As shown in FIG. 2, compensating drive 10 (the actuator according to the present invention) may include further components 1a, 11, 5, 6, in addition to components 1 and 2 mentioned above. In addition to motor 1 and measuring means 2, an analog-digital converter 11, a communication unit 5, and a pole position sensor 1a could also be included. A motor connection plug 6 must also be provided on compensating drive 10, which ensures that compensating drive 10 according to the present invention has a power connection and a signal connection to the controller and a power part. These connections could also be realized using a separate motor connection plug (not shown). Signal data could be transmitted, e.g., in an alternative manner, or partially in a wireless manner.

The position of the tongs is measured using measuring means 2 (position and/or acceleration sensor 2), which typically outputs a signal that correlates to or is proportional to the current position of the actuator. In this example, the signal behaves in a sinusoidal manner, and as a function of force F_{G} (the weight component of the device that is directed toward the center of the earth). In a plane, the following applies: F=F_{G}*sin(alpha), wherein F is the component of tongs weight F_{G} to be compensated for by compensator 10, and alpha is the angle of inclination of the device that is detected by the measuring means. The voltage signal may be transmitted to control unit 4 as an amplified analog signal or in digital form. The analog signal is converted using aforementioned analog-digital converter 11, which is connected to a computation and communication unit 5. Analog-digital converter 11 and computation and communication unit 5 could also be realized using a commercially available microcontroller, i.e., analog-digital converter 11 may also be integrated in computation and communication unit 5. Computation and communication unit 5 transmits the digital position data preferably using a protocol to control unit 4 via connecting means 8. Control unit 4 and compensating drive 10 according to the present invention are connected to one another via motor plug 6. The data on motor sensor 1a and the position data of measuring means 2 could be transmitted using connecting means 8, provided this is advantageous for the application.

FIG. 3 illustrates the mode of operation of a measuring means 2 that was used within the framework of a test set-up designed by the applicant. Measuring means 2 functions on the basis of a capacitive measurement, the capacitance changing as a function of the spacial position of the sensor (see also the explanations related to FIG. 1). Measuring means 2 delivers, as the output signal, a position-dependent, sinusoidal signal. The instantaneous value of the signal and the phase position of the signal that may be assigned to the instantaneous value correlates with the position of the measuring means in space and to the weight components to be compensated for, because the spacial position affects the distance between the capacitor plates. Even when this system is not moving, a different distance between the plates results compared to the starting position (e.g., 0°) given a certain spacial position (e.g., 90°). For this reason, a static acceleration may also be derived from this measurement signal.

Controller 4 provides two possible modes of operation:

1. Controller 4 and actuator 10, which includes integrated sensor 2, are connected to one another periodically.
2. Controller 4 and actuator 10, which includes integrated sensor 2, are connected to one another permanently.

In both cases, sensor 2 generates an analog signal. The signal may be amplified and processed further in an analog manner, or it may be sent to an analog-digital converter 11. It would also be possible to filter the signal in advance, in order to eliminate interfering quantities. If analog-digital conversion 11 takes place, the digital measured value that is therefore obtained is transmitted to controller 4, e.g., using a 12C connection or a synchronous serial protocol or an asynchronous serial protocol. Controller 4 calculates, based on the digital or analog value that was received, an initial manipulated variable (e.g., motor setpoint moment) and/or further actuator-specific manipulated variables, and forwards them to actuator 10. Controller 4 then controls motor 1 of actuator 10 directly using one of these setpoint values. Finally, the steps mentioned above are repeated, depending on which mode of operation was selected.

Housing a measuring means (sensor) 2 for detecting at least one position-dependent measured quantity inside of or directly on the actuator—be it an electrical servo motor, a hydraulic motor, or a pneumatic actuator—is novel and has the advantage that cabling and additional interference edges on the device to be moved may be eliminated.

What is claimed is:

1. An actuator for a movably situated device, in particular for a device for joining stacked adherends, in particular a pair of welding tongs, wherein
a measuring means (2) is enclosed by the actuator (10), it being possible to change at least one output signal of the measuring means depending on the spacial position, in particular within at least a plane (3) of the actuator (10).

2. The actuator as recited in claim 1, wherein a sinusoidal signal may be generated using the measuring means (2), the phase angle of which changes as a function of the spacial position of the actuator (2).

3. The actuator as recited in claim 1, wherein the tilt of the actuator (10) within the plane (3) may also be derived from the starting signal.

4. The actuator as recited in claim 1, wherein the acceleration of the actuator (10), in particular the static and/or dynamic acceleration, in particular gravitation as well, may also be derived from the starting signal.

5. The actuator as recited in claim 1, wherein the measuring means (2) is realized to be so sensitive that it is also possible to derive a vibration of the actuator (10) from the starting signal.

6. The actuator as recited in claim 1, wherein several measuring means (2) are included, thereby also making it possible to derive the position of the actuator (10) within several spacial planes (3).

7. The actuator as recited in claim 1, wherein the measuring means (2) is parametrizable in terms of the amplitude of the output signal delivered by the measuring means (2), with consideration for the force of gravity F_{G}=m*g[N].

8. A drive device comprising an actuator (10) as recited in claim 1, and comprising operating means (4) for supplying the actuator with operating data that are required to operate the actuator (10), the operating means (4) being designed such that the operating data are determined with consideration for at least one of the measured quantities that is detectable using the measuring means (2).

9. The drive device as recited in claim 8, wherein the operating means (4) is a control device or a regulating device, or a combination of a control device and a regulating device.

10. The drive device as recited in claim 8, wherein the operating means (4) is connected to the measuring means (2) using a connecting means (8), and it is realized in a manner such that the measuring means (2) is parametrizable using the operating means (4).

11. The device as recited in claim 10, wherein, to realize the connection, a data transmission means (8) is provided that is used, in particular, for the analog and/or digital transmission of data on the measuring means (2), and/or of data from another displacement-measuring device that is enclosed by the actuator (10), in order to measure the relative position of the actuator elements, which may move relative to one another.

12. The drive device as recited in claim 10, wherein the actuator (10) is a pneumatic, hydraulic, or electrical actuator (10), in particular a servo motor that includes a pole position sensor.

13. A method for operating a drive device comprising an actuator (10), and comprising operating means (4) for supplying the actuator with operating data that are required to operate the actuator (10), the operating means (4) being designed such that the operating data are determined with consideration for at least one of the measured quantities that is detectable via the measuring means (2), using the following method steps:
a) Detect the data of the measuring means (2) using the operating means (4);
b) Determine the operating data required to operate the actuator (10), with consideration for the data on the measuring means (2) that were detected using the operating means (4);
b) Operate the actuator (10) using the operating means (4), with consideration for the operating data that were detected using the operating means (4).

14. The method as recited in claim 13, wherein the operating means (4) is a control device or a regulating device, or a combination of a control device and a regulating device, and the actuator (10) is a servo motor, wherein, to operate the actuator (10), operating data are provided to the actuator (10) by the operating means (4) in the form of at least one setpoint value, in particular a current setpoint value or a moment setpoint value.

15. The method as recited in claim 13, wherein the operating means is a control device or a regulating device, or a combination of a control device and a regulating device, and the actuator (10) is a pneumatic actuator or a hydraulic actuator wherein, to operate the actuator (10), operating data are provided by the operating means (4) in the form of at least one setpoint value, in particular a pressure setpoint value.

16. The method as recited in claim 13, wherein the operating means (4) also parametrizes the measuring means (2), preferably parametrizing the amplitude of the signal delivered by the measuring means (2), with consideration for the force of gravity F_{G}=m*g[N].

17. The method as recited in claim 13, wherein the operating means (4) processes data on the measuring means, and data from another displacement measuring device that is enclosed by the actuator (10), in order to measure the relative position of actuator elements that are movable relative to one another, these data being transmitted in a digital and/or analog manner between the actuator (10) and the operating means (4).
